(19) United States
(12) Patent Application Publication
(10) Pub. No.: US 2003/0014890 A1
(43) Pub. Date: Jan. 23, 2003

(54) Indicia carrier

(75) Inventor: Itzchak Bar-Yona, Givat-Haslayim (IL)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Multi Vision Technologies Ltd., New Industrial Zone (IL)

(21) Appl. No.: 09/977,381

(22) Filed: Oct. 16, 2001

(30) Foreign Application Priority Data
Jul. 19, 2001 (IL) 144462

(51) Int. Cl. G03B 25/02

(52) U.S. Cl. 40/454

(57) ABSTRACT

An indicia carrier film suitable for producing consecutively changing images in harmonious fashion. The indicia carrier includes a display unit housing provided with at least one panel formed from an array of linear lenses, a displaceable indicia carrier film which is disposed within the housing at a distance from the rear face of the lenticular panel equaling the focal length of the lenses, and a drive means for periodically displacing the indicia carrier relative to the lenses. The ratio of film weight to surface area is greater than 1:100 gm/cm². The total weight of the film is not greater than 10 gm for an indicia carrier of approximate A4 dimensions (17×29.5 cm). The modulus of elasticity is of at least 600 Mpa.

### FIELD OF THE INVENTION

The present invention relates to an indicia carrier in the form of a flexible film, which is suitable for use with self-powered display units based on lenticular technology.

### BACKGROUND OF THE INVENTION

U.S. Pat. No. 6,226,906 discloses a self-powered display unit for displaying several consecutively changing images, and its description is fully incorporated herein by reference. Such a display unit consists of a housing provided with a panel formed from an array of linear lenses, a displaceable, light-weight indicia carrier, in the form of a film, which is disposed within the housing at a distance from the rear face of the lenticular panel equaling the focal length of the lenses, and a high-efficient, battery powered drive means requiring low energy consumption for periodically displacing the indicia carrier relative to the lenses. The rotation of a cam is configured to correspond to such a linear displacement of an indicia carrier so as to effect a consecutive display of the images formed on the surface of the indicia carrier. The present invention relates to the technology disclosed in the aforementioned patent, and therefore details of the generation of dynamic images, which can be appreciated by the skilled person by a reading of the aforementioned patent, are not repeated herein, for the sake of brevity.

It has now been surprisingly found that in order for the device of U.S. Pat. No. 6,226,906 to function properly, the physical characteristics of the indicia carrier need to be within certain specific ranges. Use of indicia carriers that do not obey the constraints according to the present invention results in a less efficient operation of the display apparatus, and in some cases to a severe malfunctioning thereof. In general, two constraints determine the performance of a display unit: the dimensions of a narrow planar cavity which receives the indicia carrier and the torque provided by the drive means which displaces the indicia carrier. The planar cavity must be accurately produced, at slightly larger dimensions than the indicia carrier film, to ensure that the indicia provided with the carrier film are located at the locus, or focal points, of the lenses. Free movement of the film is indispensable for the proper functioning of the display unit. A display unit, as referred to hereinafter, is defined by a device, regardless of its size, shape or function, that is capable of displaying several consecutively changing images in harmonious fashion.

It is therefore an object of the present invention to provide an inexpensive indicia carrier suitable for producing consecutively changing images in harmonious fashion within a self-powered display unit.

It is a further object of the present invention to provide indicia carriers that are free from any characteristics that may lead to the malfunctioning of the display apparatus.

Other objects and advantages of the invention will become apparent as the description proceeds.

### SUMMARY OF THE INVENTION

The invention is directed to an indicia carrier film suitable for producing consecutively changing images in harmonious fashion within a display unit housing provided with at least one panel formed from an array of linear lenses, a displaceable indicia carrier film which is disposed within the housing at a distance from the rear face of the lenticular panel equaling the focal length of the lenses, and a drive means for periodically displacing the indicia carrier relative to the lenses, characterized in:

a. a ratio of film weight to surface area of greater than 1:100 gm/cm²;

b. a modulus of elasticity of at least 600 MPa; and

c. optionally, provision of a coating of an antistatic agent to said film.

In a preferred embodiment, the weight of a film of approximate A4 dimensions (17×29.5 cm) is preferably no greater than 10 gm, and its thickness is no greater than 0.2 mm, and preferably ranges from 0.05 to 0.2 mm. Thus, as will be appreciated by the skilled person, there is a narrow preferred range in which, according to this preferred embodiment of the invention, it is possible to use a film, i.e., a preferred film must possess both a ratio of film weight to surface area of greater than 1:100 gm/cm² and a maximal weight of no more than 10 gr for an A4 sheet. The skilled person will easily appreciate the relevant range for sheets of dimensions other than A4, or of shapes other than rectangular.

The term “film”, as used herein, is meant to indicate any essentially flat sheet of material that obeys the conditions described herein, and on which indicia can be printed, without limitation to the specific material of which it is made.

The most difficult goal to be achieved in order to produce a self-powered display unit using lenticular technology is the cumulative pitch tolerance of the lenses relative to the cumulative pitch tolerance of the indicia, or the printed matter. To attain an optimal cumulative pitch tolerance of the lenses relative to the displaceable indicia carrier, a predetermined value of film rigidity must be maintained, when the ambient temperature ranges from −10° C. to +40° C., to prevent excessive film flexure during displacement, so that the effective film height difference is no greater than 0.05 mm, when being vertically displaced.

The film is preferably formed with a guide means in order to achieve maximum alignment. The guide means is preferably comprised of an upper and lower elongated slot, such that a vertical line connecting the horizontal midpoint of each elongated slot is perpendicular to each row of linear lenses. The perpendicularity between the printed lines and an edge of the indicia carrier is preferably less than 0.1 degree.

The film material is preferably selected from the group consisting of polycarbonate and polyester.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 illustrates a front view of one embodiment of a display unit in which the front panel is removed;

FIG. 2 illustrates an enlarged representation of the display unit of FIG. 1;

FIG. 3 illustrates a vertical cross-sectional view of the display unit of FIG. 2 in which an indicia carrier is disposed two lenticular panels;

FIG. 4 illustrates a front view of a second embodiment of a display unit provided with a guide means for the indicia carrier;

FIG. 5 illustrates a vertical cross-sectional view of the display unit of FIG. 4 in which an indicia carrier is disposed between a front lenticular panel and a rear panel;

FIG. 6 is an enlargement of FIG. 4 in which the indicia carrier is shown to flex;

FIG. 7 is an enlargement of FIG. 4 in which a large film effective height difference is shown;

FIG. 8 illustrates an optical manufacturing method to maximize film alignment;

FIG. 9(a) is an illustration of a substantially rectangular indicia carrier shape; and

FIG. 9(b) is an illustration of an indicia carrier having a circular shape.

### DETAILED DESCRIPTION OF PREFERRED EMBODIMENTS

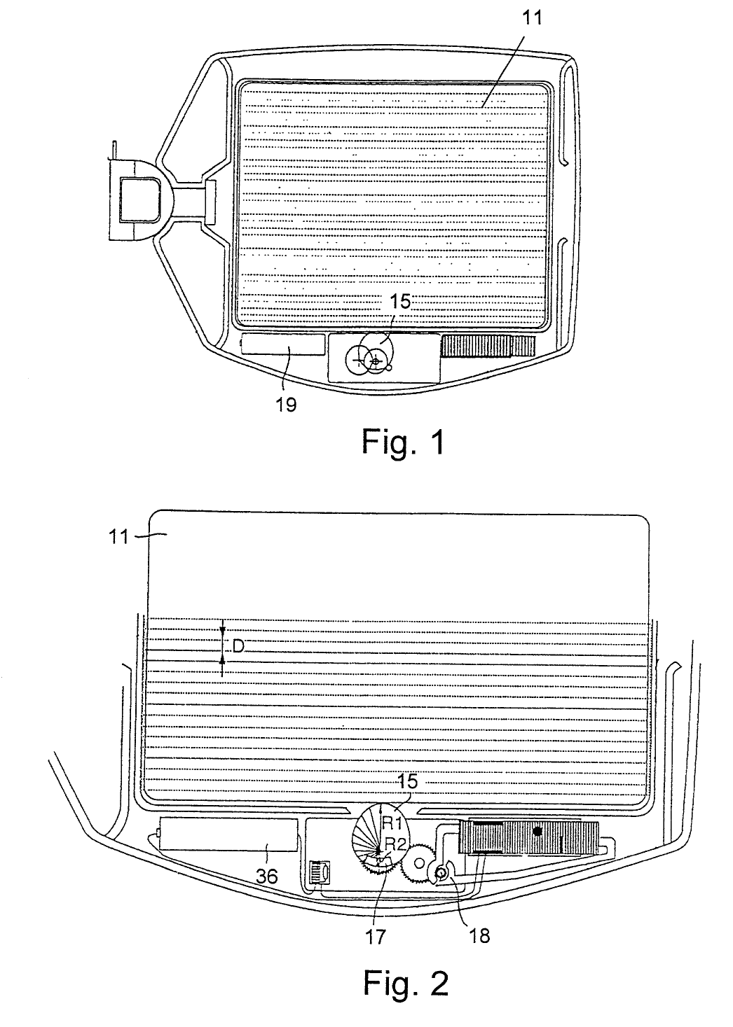

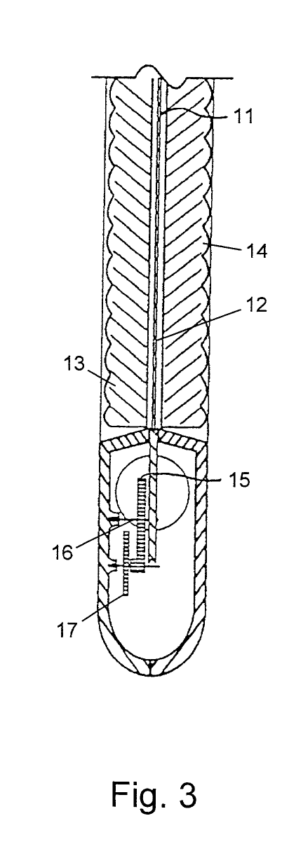

One illustrative embodiment of a display unit is shown in FIGS. 1-3. Indicia carrier film 11 is inserted within planar cavity 12 formed between front and rear lenticular panels 13 and 14, respectively. A unit with two separate panels is suitably displayable for those areas at which observers pass the display units in two separate directions. The lower edge of film 11 is engageable with cam 15, which periodically vertically displaces film 11 a distance of “D”, substantially equal to the distance between focal lines of adjacent lenses. In this description the indicia carrier is assumed to be vertically displaced, but it should be appreciated that a display unit may also be used such that the indicia carrier is horizontally displaced.

Cam 15, which rotates about shaft 16, is connected to gear train 17, which is driven by micro-impulse motor 18. The power consumption of motor 18 is small enough, such that it is sufficiently energized by one standard AA battery 19 for a period of two months without replacement.

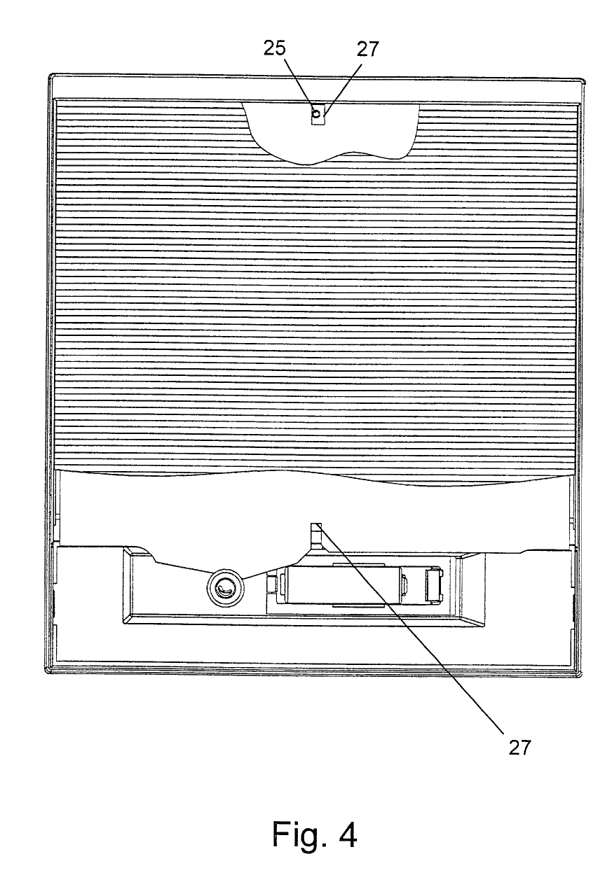

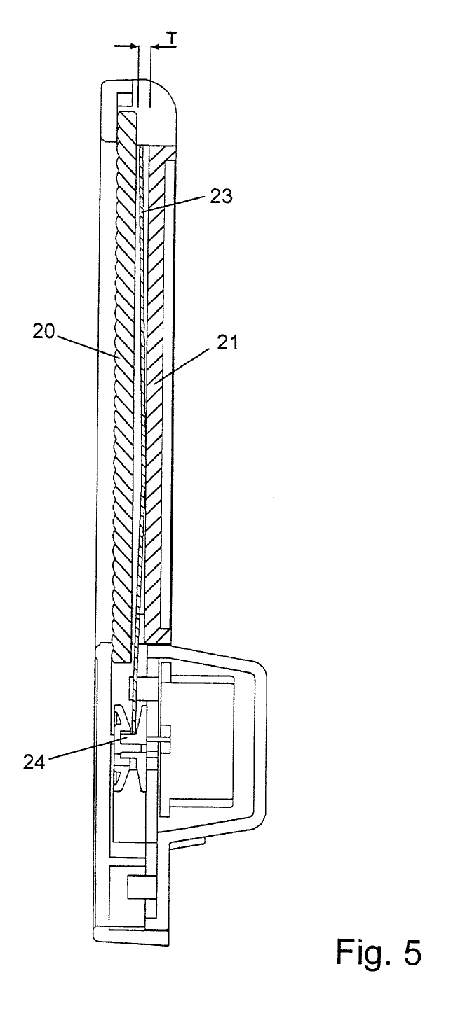

A second illustrative embodiment of a display unit is shown in FIGS. 4-5. This unit is provided with one lenticular panel and is suitable for counter displays. A planar cavity of uniform thickness “T” is formed between front lenticular panel 20 and rear panel 21. Indicia carrier film 23 is vertically displaced by cam 24, which periodically contacts the bottom edge thereof. Upper and lower elongated slots 27 are formed in the indicia carrier, into which a corresponding pin 25 protrudes from rear panel 21, such that the width of elongated slot 27 is substantially equal to the diameter of pin 25 to ensure correct alignment of film 23 during displacement. Each elongated slot 27 is preferably formed equidistantly from the lateral edges of indicia carrier 23, e.g. at a spacing of about 18.0 cm.

Four parameters describe the effectiveness of an indicia carrier to be used with a self-powered display unit:

A. Ratio of Weight to Surface Area

B. Antistatic Properties

C. Cumulative Pitch Tolerance

D. Alignment

Ratio of Weight to Surface Area

In the two embodiments described in FIGS. 1-5, the indicia carrier film is vertically displaced. While being upwardly displaced by means of the cam, the indicia carrier returns to its original position by gravity. Since the duty cycle of the drive means is such that it is not in constant operation, the longevity of the standard alkaline battery energizing the motor is therefore significantly increased.

The torque of the drive means is selected in order to fulfill a fundamental requirement of the display unit, namely independent operation of at least two months by a standard AA battery without replacement. For example, a micro step motor, when employed, cannot produce a torque larger than 4-5 gm-cm when rotating the cam at a speed of 4 rpm. Due to this limitation of maximum permissible torque, an upper limit of 10 gm relating to the maximum permissible weight of the indicia carrier film is therefore established for this particular preferred embodiment. The film thickness is consequently limited as well, for a given film height, from 50μ to 300μ, and preferably a thickness of 100 microns.

A lower limit of acceptable film weight also exists. When the weight of the indicia carrier film is too low, resisting frictional and electrostatic forces retard, or even halt, its downward displacement after being upwardly displaced by the cam. An electrostatic force tends to attract the film to one of the panels, thereby hampering free movement. In an embodiment in which the film is horizontally disposed, frictional and electrostatic forces are applied in each lateral direction and oppose the rotation of the cam.

Since an electrostatic charge is proportional to surface area, the surface area of the indicia carrier film is a meaningful factor in determining film effectiveness. The ratio between the weight of the film and its surface area is also an essentially important characteristic, and an optimal ratio was experimentally determined to be 1:100 gm/cm².

The following table demonstrates, by example only, one of the design considerations involved in deciding which type of substrates are suitable for use in a display unit. It would be appreciated that a limited number of substrate types are available due to the two aforementioned mutually contradictory characteristics, namely a) a ratio between the weight of the film and its surface area of at least 1:100 gm/cm² and b) a film weight less than 10 gm. The surface area of the film is assumed to be a standard A1 size of 600 square centimeters.

| | | Weight | Ratio | |
|---|---|---|---|---|
| No. | Substrate | (gm) | (gm/cm²⁾ | Suitable |
| 1 | Polycarbonate 200 μ | 14.6 | 1/42 | No |
| 2 | Polyester 100 μ | 9.7 | 1/62 | Yes |
| 3 | Polyester 50 μ | 4.8 | 1/125 | No |
| 4 | Paper 100 μ | 4.8 | 1/129 | No |

Substrate No. 1 was determined to be not suitable since its weight is greater than 10 gm. Substrate Nos. 3 and 4, even though their weight is within the acceptable limit, are not suitable to be used for a display unit since their weight to surface area ratio is less than 1/100 gm/cm². As a result, the only one substrate of those compared in this table was found to be suitable, namely Polycarbonate 100μ.

Antistatic Properties

As two different materials, i.e. insulating materials, are brought in contact with each other and then separated, chemical bonds are formed when the surfaces touch. Imbalances of opposite polarity are therefore induced, hereinafter referred to as an “electrostatic charge,” such that one surface has more electrons than protons, while the other has more protons than electrons. When rejoined, an electrostatic force is generated that attracts two adjacent surfaces, each of which has regions of an opposite electrostatic charge. Under normal conditions, water droplets in the surrounding air conduct any electrostatic charge from a surface, and therefore an electrostatic force between two surfaces in contact is therefore not noticeable. An electrostatic force tends to be produced during dry weather conditions when the low number of water droplets in the surrounding air are not capable of sufficiently conducting an electrostatic charge from the associated surfaces.

An electrostatic charge is produced on an indicia carier film as it is displaced relative to a lenticular panel, and low humidity therefore enhance the attraction of the film to the lenticular panel. In order to ensure a harmonious transition between consecutively changing images, electrostatic charge generation on the indicia carrier film has to be minimized to enable smooth and continuous indicia carrier displacement. As a result the film preferably needs to be treated so that it may be imparted with needed antistatic properties.

In one approach, a conductive agent is applied to the indicia carrier to thereby provide the plastic material of the film with metallic properties which prevent a generation of an electrostatic charge. In a second approach the film surface is sprayed with a hydrophilic agent. With the addition of this agent, the film acquires a capacity of being constantly saturated with water molecules, thus neutralizing cationic or anionic charges, depending on the agent employed.

Several products for the prevention of an electrostatic charge imbalance are commercially available. For example, Staticid®, a solution produced by ACL Inc., can be applied by spraying or wiping the indicia carrier film after printing and die cutting. The solution may be water or alcohol-based, depending on the sensitivity of the material used for the production of the film. This solution is inexpensive and may be easily applied, and provides the film with long-term antistatic properties, even during low humidity.

Cumulative Pitch Tolerance

The most difficult goal to be achieved in order to produce a self-powered display unit using lenticular technology is the cumulative pitch tolerance of the lenses relative to the cumulative pitch tolerance of the indicia carried by the film, hereinafter referred to as lines of printed matter. Cumulative pitch tolerance of the lenses refers to the distance between the uppermost point, when an indicia carrier is vertically displaced, of the top row of lenses and the uppermost point of the bottom row of lenses. In order to maintain an optimal relative cumulative pitch tolerance, thermal expansion, manufacturing inaccuracies and other factors are considered.

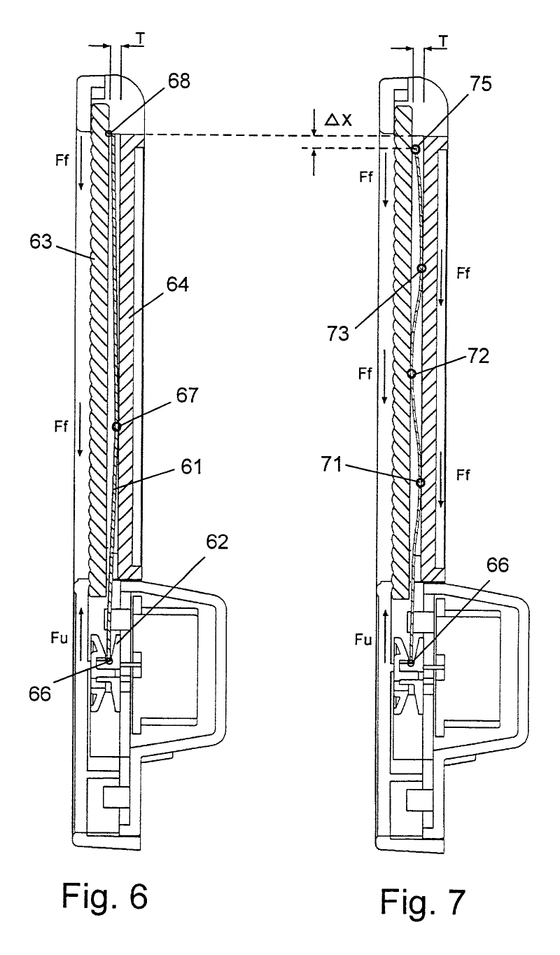

FIGS. 6 and 7 illustrate the complexity of ensuring an accurate relative cumulative pitch tolerance in reference with the embodiment of the display unit shown in FIG. 5. As shown in FIG. 6, indicia carrier 61, the pitch tolerance of which is within acceptable limits, is upwardly displaced by cam 62 by a force designated by Fᵤ. Force Fᵤ, which is needed to displace indicia carrier 61 a distance D (see FIG. 1) corresponding to the distance between focal lines of adjacent lenses, has to overcome frictional forces F_{f} in addition to weight W of the indicia carrier. During normal displacement, indicia carrier 61 develops a convex flexure. Due to the flexure, indicia carrier contacts at least two, but no more than three points, of the display unit: contact point 66 of cam 62, contact point 67 of rear panel 64, and at times, due to the positioning of the indicia carrier, contact point 68 of lenticular panel 63. At each contact point a frictional force F_{f} exists. Assuming that the forces resulting from acceleration of the film and from the frictional forces that are induced by contact with the elongated slots are negligible the resulting equation for a balance of forces is:

Fᵤ=2(F_{f})+W

At times, indicia carrier 61 is not rigid enough, and as a result a plurality of ripples develops as shown in FIG. 7. Accordingly the indicia carrier contacts the display unit at additional points, thereby causing additional frictional forces. The resulting equation for the balance of forces is:

Fᵤ=4(F_{f})+W

In addition to added load on the motor and reduced longevity for the battery, the additional contact points 72, 73 and 74 cause a shortened effective film height. Instead of having an effective film height extending from contact point 66 to contact point 68, the effective film height is shortened by a difference of Δx and extends from contact point 66 to contact point 75.

Since the indicia of film 61 is produced and printed at tolerances on the order of microns, a distortion of the dynamic image generated from the display unit is readily seen when the film height difference Δx is greater than 0.05 mm. A predetermined rigidity of the film, dependent upon the moment of inertia thereof, due to the selected shape of the indicia carrier, which must be retained even during a temperature range of −10° C. to +40° C., is controllable by changing its modulus of elasticity, normally referred to as Young's module. It has been experimentally found that the modulus of elasticity must be at least 600 MPa to prevent significant shortening of the effective film height, as described hereinbefore.

Alignment

Indicia carrier 23, as described hereinbefore in reference to FIG. 4, is die-cut to an accurate shape. Upper and lower elongated slots 27, in addition to the corresponding pin 25 that protrudes therein, serve as a guiding means to ensure the parallelism of the printed lines with respect with the linear lenses during displacement of the indicia carrier. It is needless to say that a vertical line connecting the horizontal midpoint of each elongated slot is perpendicular to each row of linear lenses. Any other means, which is well known to those skilled in the art, that ensures the parallelism of the printed lines with respect with the linear lenses during displacement of the indicia carrier may be similarly employed.

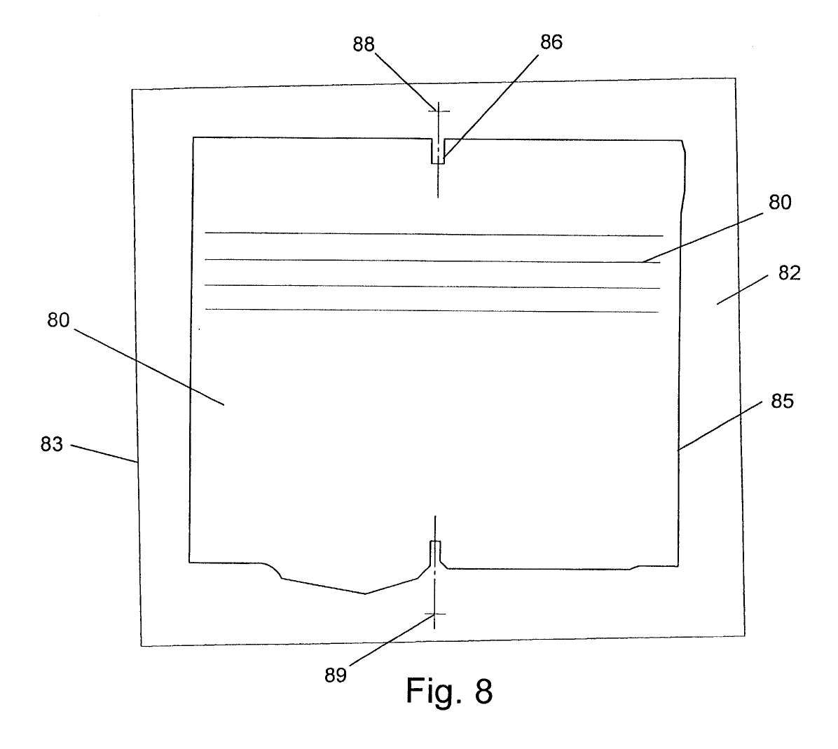

The necessity of accurate film cutting is illustrated in FIG. 8. Standard mass production methods cannot ensure the perpendicularity of edge 83 of an uncut print with respect to each indicia, 80, i.e. the printed lines. Indicia 80 are not printed in a constant relationship with respect to margins 82 of a rectangular print and at times are oblique to edge 83. Also, conventional cutting methods are such that a guillotine is lowered onto a pile on prints, which have been mutually aligned by a straightening board, and an angular deviation of up to one-half of a degree between edge 83 of a print and edge 85 of an indicia carrier, formed following the cutting procedure, may result.

To ensure proper alignment, the indicia carrier film is cut by referring to two markers 88 and 89 that are positioned above and below, respectively, indicia 80. An optical identification means (not shown) locates markers 88 and 89, and ensures that a line connecting the two markers is perpendicular to indicia 80 during the cutting procedure and passes through the midpoint of elongated slots 86, which serve as a guiding means during displacement. As a result, perpendicularity between indicia 80 and edge 85 of the cut indicia carrier is maintained to be less than 0.1 degree.

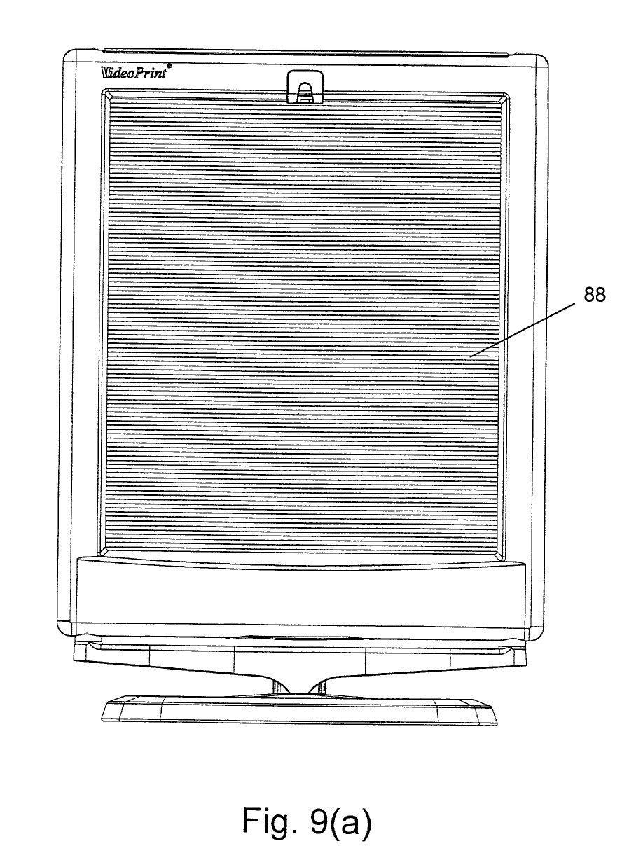

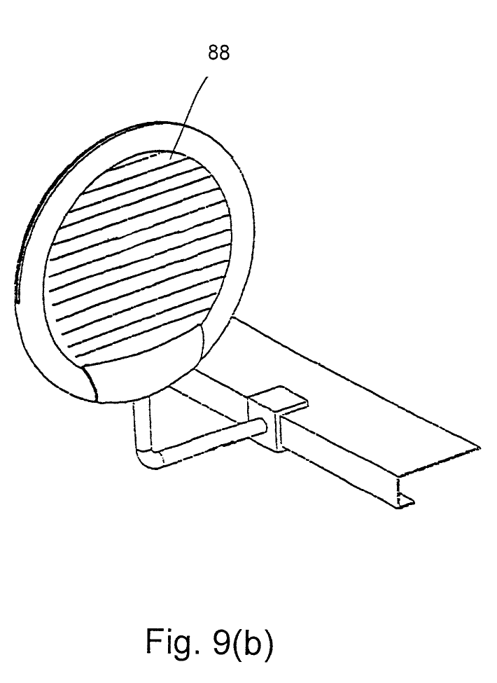

As shown in FIG. 9, indicia carrier film 88 may be produced with any desirable shape. In FIG. 9(a) film 88 is produced with a substantially rectangular shape, and in FIG. 9(b) with a circular shape. Despite the unique die-form of each film, the parallelism of each display unit between indicia and the linear lenses is the same, a value of less than 0.1 degree.

In conclusion, effective display unit performance dictates referral to all four of the aforementioned parameters of an indicia carrier. Consequently, the substrate of the indicia carrier should preferably be selected from the group of plastic films, such as polycarbonate and polyester (PET), since they are lightweight, have a sufficient ratio of weight to surface area, do not form ripples while being displaced and are impervious to moisture during conditions of high humidity or application of an antistatic agent. However, an indicia carrier may also be made from a metallic foil, for example, which has a low weight and high rigidity without generation of an electrostatic charge. Although plastic films are structurally acceptable, nevertheless poor absorption of colors results during printing. To overcome this problem, it is desirable to apply a special coating prior to printing and electrostatic treatment. For example, Durakote™ is suitable for PET substrates since it has been optimized for a digital press. Also, this coating prevents shrinkage or curling of the film during the printing process.

As the planar cavity of each display unit has been carefully designed to retain the indicia carrier within the proper focal distance, the manufacturing of the film with respect to the four aforementioned parameters ensures proper functioning and good repeatability of the display unit.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A displaceable indicia carrier film suitable for producing consecutively changing images, said display unit housing being within a display unit housing provided with at least one lenticular panel having a rear face and formed from an array comprising plural rows of linear lenses having a focal length, said displaceable indicia carrier film being disposed within the housing at a distance from the rear face of the lenticular panel equaling the focal length of the lenses, and a drive means for periodically displacing the indicia carrier film relative to the lenses, wherein:
a ratio of weight of said film to a surface area of said film is greater than 1:100 gm/cm²;
a total weight of the film is not greater than 10 gm for an indicia carrier film of substantially A4 dimensions (17×29.5 cm); and
a modulus of elasticity of said film is at least 600 Mpa.

2. The indicia carrier film of claim 1, further comprising a coating of an antistatic agent.

3. The indicia carrier film of claim 1, wherein the film thickness is no greater than 200 μm.

4. The indicia carrier film of claim 3, wherein the film thickness ranges from 50 μm to 200 μm.

5. The indicia carrier film of claim 1, wherein an effective variation in film displacement is no greater than 0.05 mm, when the indicia carrier film is displaced.

6. The indicia carrier film of claim 1, further comprising means for aligning an edge of the film with respect to printed lines thereon.

7. The indicia carrier film of claim 6, further formed with an upper and a lower elongated slot, such that a vertical line connecting a horizontal midpoint of each elongated slot is perpendicular to each of said plural rows of linear lenses.

8. The indicia carrier film of claim 7, wherein a deviation from a perpendicular angle between the printed lines and said edge of the indicia carrier film is less than 0.1 degree.

9. The indicia carrier film of claim 1, wherein a film material is selected from the group consisting of polycarbonate and polyester.
